(19) United States
(12) Patent Application Publication
(10) Pub. No.: US 2015/0379322 A1
(43) Pub. Date: Dec. 31, 2015

(54) METHOD AND APPARATUS FOR COMMUNICATION USING FINGERPRINT INPUT

(71) Applicant: Samsung Electronics Co., Ltd., Suwon-si (KR)

(72) Inventors: Suha YOON, Seoul (KR); Suyoung PARK, Uiwang-si (KR); Jingil YANG, Suwon-si (KR)

(21) Appl. No.: 14/755,519

(22) Filed: Jun. 30, 2015

(30) Foreign Application Priority Data
Jun. 30, 2014 (KR) 10-2014-0080705

(51) Int. Cl. G06K 9/00; G06F 21/32

(52) U.S. Cl. CPC G06K 9/0002; G06K 9/00087; G06F 21/32

(57) ABSTRACT

A method for communication using a fingerprint input is provided. The method includes detecting a fingerprint information input, changing a communication mode according to the fingerprint information input, detecting a peripheral electronic device operating in a fingerprint mode, if the changed communication mode is the fingerprint mode, and communicating with the detected peripheral electronic device.

### CROSS-REFERENCE TO RELATED APPLICATION(S)

This application claims the benefit under 35 U.S.C. §119(a) of a Korean patent application filed on Jun. 30, 2014 in the Korean Intellectual Property Office and assigned Serial number 10-2014-0080705, the entire disclosure of which is hereby incorporated by reference.

### TECHNICAL FIELD

The present disclosure relates to a method and an apparatus for communication using a fingerprint input.

### BACKGROUND

According to developments in communication technology, recent electronic devices can perform communication between devices by using Bluetooth, Near Field Communication (NFC), and Wireless Fidelity (WiFi). Accordingly, transmission and reception of contents between electronic devices can be easily performed. For transmitting and receiving contents, various communication methods between devices are used, and a pairing method (for example, S-BREAM) between devices in a close distance can be utilized by using NFC or WiFi.

In the meantime, a communication method of the related art has inconvenience because two devices to be connected must be located in a very short distance. In some cases, paring between devices can be enabled even though the devices don't approach each other. However, security problems can be generated when connecting through a communication channel. Therefore, a method for solving the security problems is required when communicating in a relatively long distance.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method for enabling communication between electronic devices even though the devices do not approach each other so that the communication can be supported in a longer distance.

Another aspect of the present disclosure is to provide a method for supporting a more stable security function by identifying whether fingerprint information is identical and by connecting the devices if the fingerprint information is identical.

In accordance with an aspect of the present disclosure, a method for communication using a fingerprint input is provided. The method includes detecting a fingerprint information input, changing a communication mode according to the fingerprint information input, detecting a peripheral electronic device operating in a fingerprint mode, if the changed communication mode is the fingerprint mode, and communicating with the detected peripheral electronic device.

In accordance with another aspect of the present disclosure, an apparatus for performing communication using a fingerprint input is provided. The apparatus includes a communication module, a fingerprint sensor configured to input a fingerprint, a control unit configured to change a communication mode according the fingerprint input, to control the communication module to search a peripheral electronic device operating in a fingerprint mode if the changed communication mode is the fingerprint mode, and to control to communicate with the detected peripheral electronic device operating in the fingerprint mode, and a storage unit configured to store user's fingerprint information in order to identify whether the input fingerprint is a user's fingerprint.

In accordance with another aspect of the present disclosure, a non-transitory computer-readable storage media configured to store a program including instructions for execution by at least one processor is provided. The program includes first instructions for detecting a fingerprint information input, second instructions for changing a communication mode according to the fingerprint information input, third instructions for detecting a peripheral electronic device operating in a fingerprint mode, if the changed communication mode is the fingerprint mode, and fourth instructions for communicating with the detected peripheral electronic device.

Various embodiments of the present disclosure can support communication between electronic devices even when the devices to communicate each other are not located in the vicinity, and support a more stable security function in the communication between devices.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a network configuration including an electronic device according to various embodiments of the present disclosure;

FIG. 2 is a drawing illustrating an example of electronic device according to an embodiment of the present disclosure;

FIG. 3 is a block diagram illustrating a schematic configuration of electronic device according to an embodiment of the present disclosure;

FIGS. 4A and 4B are flowcharts illustrating a procedure of communication connection performed in an electronic device according to an embodiment of the present disclosure;

FIGS. 5A and 5B are flowcharts illustrating a procedure of establishing communication between electronic devices by using fingerprint mode information according to an embodiment of the present disclosure;

FIG. 6 is a block diagram illustrating a format of connection request signal according to an embodiment of the present disclosure;

FIGS. 7A and 7B are screen examples illustrating a search list of connectible peripheral electronic devices in an electronic device according to an embodiment of the present disclosure;

FIG. 8 is a flowchart illustrating a procedure of displaying a search list of connectible peripheral electronic devices in an electronic device according to various embodiments of the present disclosure;

FIG. 9 is a block diagram illustrating a configuration of electronic device according to various embodiments of the present disclosure; and

FIG. 10 is a flowchart illustrating communication protocols between electronic devices according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Hereinafter, ‘fingerprint mode’ is used as a term of mode in which a communication module is operated by activating with a fingerprint input. Namely, if a specific communication module is activated by accompanying a fingerprint input (a method of accompanying a fingerprint mode may be applied in various ways), the communication module can be activated in the fingerprint mode.

In the embodiment of the present disclosure, ‘normal mode’ is used as a term of mode in which a communication module is activated without accompanying a fingerprint mode. Namely, when a specific communication module is activated, the communication module may maintain a state of fingerprint mode or normal mode.

It will be understood that the expressions “comprises” and “may comprise” is used to specify presence of disclosed function, operation, component, etc. but do not preclude the presence of one or more functions, operations, components, etc. It will be further understood that the terms “comprises” and/or “has” when used in this specification, specify the presence of stated feature, number, operation, component, element, or a combination thereof but do not preclude the presence or addition of one or more other features, numbers, operations, components, elements, or combinations thereof.

In an embodiment of the present disclosure, the expression “and/or” is taken as specific disclosure of each and any combination of enumerated things. For example, A and/or B is to be taken as specific disclosure of each of A, B, and A and B.

As used herein, terms such as “first,” “second,” etc. are used to describe various components but not restrict the corresponding components. However, it is obvious that the components should not be defined by these terms. The terms are used only for distinguishing one component from another component. For example, a first component may be referred to as a second component and likewise, a second component may also be referred to as a first component, without departing from the teaching of the inventive concept.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present.

The terminology used herein is for the purpose of describing particular embodiments only and is not intended to be limiting of the present disclosure.

Unless otherwise defined, all terms used herein have the same meaning as commonly understood by one of ordinary skill in the art to which this present disclosure pertains, and should be interpreted neither as having an excessively comprehensive meaning nor as having an excessively contracted meaning. The general terms used herein should be interpreted according to the definitions in the dictionary or in the context and should not be interpreted as an excessively contracted meaning.

In the following description, the electronic device may be a device having a communication function. Examples of the electronic device may include at least one of a smartphone, a tablet Personal Computer (PC), a mobile phone, a video phone, an electronic book (ebook) reader, a desktop PC, a laptop PC, a netbook PC, a Personal Digital Assistant (PDA), a Portable Multimedia Player (PMP), an MP3 player, a mobile medical appliance, a camera, a wearable device (e.g. head-mounted-device (HMD) such as electronic glasses), an electronic clothing, an electronic bracelet, an electronic neckless, an appcessory, an electronic tattoo, or a smart watch.

According to various embodiments, examples of the electronic device may be a smart home appliance having a communication function. Examples of the smart home appliance may include at least one of a television (TV), a Digital Video Disc (DVD) player, an audio player, a refrigerator, an air conditioner, a cleaner, an oven, a microwave oven, a laundry machine, an air cleaner, a set-top box, a TV box (e.g. Samsung HomeSync™, Apple TV™, and Google TV™), a game console, an electronic dictionary, an electronic key, a camcorder, or an electronic frame.

According to various embodiments, examples of the electronic device may include at least one of a medical appliance (e.g. Magnetic Resonance Angiography (MRA), Magnetic Resonance Imaging (MRI), Computed Tomography (CT), camera, and ultrasonic device), a navigation device, a Global Positioning System (GPS) receiver, an Event Data Recorder (EDR), a Flight Data Recorder (FDR), a car infotainment device, an electronic equipment for ship (e.g. marine navigation device and gyro compass), avionics device, security device, a Head Up Display (HUD), an industrial or home robot, an Automatic Teller Machine (ATM) of a financial institution, or a Point Of Sales (POS).

According to various embodiments, examples of the electronic device may include furniture or part of building/construction which has a communication function, an electronic board, an electronic signature receiving device, a projector, and a metering device (e.g. water, electricity, and electric wave metering devices). According to an embodiment, the electronic device may be one or any combination of the above enumerated devices. According to an embodiment, the electronic device may be a flexible device. However, it is obvious to those in the art that the electronic device of the present disclosure is not limited to the above devices.

A description is made of the electronic device according to various embodiments with reference to accompanying drawings hereinafter. In the description of the various embodiments, the term ‘user’ may denote a person or a device (e.g. intelligent electronic device) which uses the electronic device.

Hereinafter, ‘fingerprint mode’ is used as a term of mode in which a communication module is operated by activating with a fingerprint input. Namely, if a specific communication module is activated by accompanying a fingerprint input (a method of accompanying a fingerprint mode may be applied in various ways), the communication module can be activated in the fingerprint mode.

In the embodiment of the present disclosure, ‘normal mode’ is used as a term of mode in which a communication module is activated without accompanying a fingerprint mode. Namely, when a specific communication module is activated, the communication module may maintain a state of fingerprint mode or normal mode.

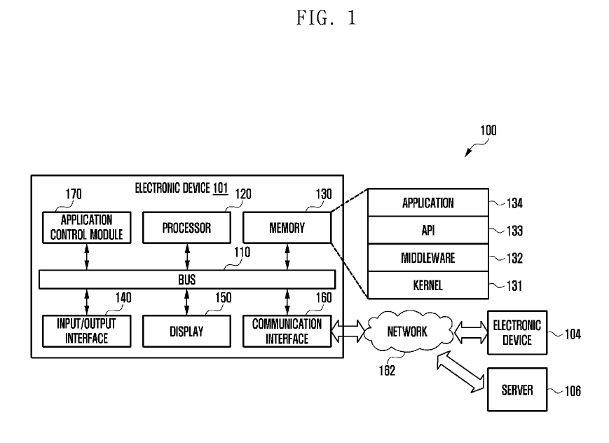

FIG. 1 is a block diagram illustrating a network configuration 100 including an electronic device 101 according to various embodiments of the present disclosure.

Referring to FIG. 1, the electronic device 101 may include a bus 110, processor 120, memory 130, input/output interface 140, display 150, communication interface 160, and function processing module 170.

The bus 110 may be a circuitry which connects the aforementioned components to each other to communicate signals (e.g. control messages) therebetween.

The processor 120 receives a command from any of the aforementioned components (e.g. memory 130, input/output interface 140, display 150, communication interface 160, and function processing module 170) through the bus 110, interprets the command, and executes operation or data processing according to the decrypted command.

The memory 130 may store the command or data received from the processor 120 or other components (e.g. input/output interface 140, display 150, communication interface 160, function processing module 170, etc.) or generated by the processor 120 or other components. The memory 130 may store program modules including kernel 131, middleware 132, Application Programming Interface (API) 133, applications 134, etc. Each programming module may be implemented as software, firmware, hardware, and any combination thereof.

The kernel 131 may control or manage the system resources (e.g. bus 110, processor 120, and memory 130) for use in executing the operation or function implemented with the middleware 132, the API 133, or the application 134. The kernel 131 also may provide an interface allowing the middleware 132, API 133, or application 134 to access the components of the electronic device 101 to control or manage.

The middleware 132 may work as a relay of data communicated between the API 133 or application 134 and the kernel 131. The middleware 132 may execute control of the task requests from the applications 134 in such a way of assigning priority for use of the system resource (e.g. bus 110, processor 120, and memory 130) of the electronic device to at least one of the applications 134.

The API 133 is the interface for the applications 134 to control the function provided by the kernel 131 or the middleware 132 and may include at least one interface or function (e.g. command) for file control, window control, image control, or text control.

According to various embodiments, the applications 134 may include Short Message Service (SMS)/Multimedia Messaging Service (MMS) application, email application, calendar application, alarm application, health care application (e.g. application of measuring quantity of motion or blood sugar level), and environmental information application (e.g. atmospheric pressure, humidity, and temperature applications). Additionally or alternatively, the application 134 may be an application related to information exchange between the electronic device 101 and other external electronic device (e.g. electronic device 104). Examples of the information exchange application may include a notification relay application for relaying specific information to the external electronic device 104 and a device management application for managing the external electronic device.

For example, the notification relay application may be provided with a function of relaying the alarm information generated by the other applications (e.g. SMS/MMS application, email application, health care application, and environmental information application) of the electronic device to an external electronic device (e.g. electronic device 104). Additionally or alternatively, the notification relay application may provide the user with the notification information received from an external electronic device (e.g. electronic device 104). The electronic device application may manage (e.g. install, delete, and update) the function of an external electronic device (e.g. turn-on/off of the electronic device 104 itself (or a part of it) or adjustment of the brightness (or resolution) of the display) which communicates with the electronic device 101 or the service (e.g. communication or messaging service) provided by the external electronic device or an application running on the external device.

According to various embodiments, the applications 134 may include an application designated according to the property (e.g. type) of an external electronic device (electronic device 104). If the external electronic device is the MP3 player, the applications 134 may include a music playback application. Similarly, if the external electronic device is a mobile medical appliance, the applications 134 may include a heal care application. According to an embodiment, the application 134 may include at least one of applications designated to the electronic device 101 or the applications received from the external electronic device (e.g. server 106 and electronic device 104).

The input/output interface 140 delivers the command or data input by the user through with an input/output device (e.g. sensor, keyboard, and touchscreen) to the processor 120, memory 130, communication interface 160, and/or function processing module 170 through the bus 110. For example, the input/output interface 140 may provide the processor 120 with the data corresponding to the touch may by the user on the touchscreen. The input/output interface 140 may output the command or data (which is received from the processor 120, memory 130, communication interfaced 160, or the function processing module 170 through the bus 110) through the input/output device (e.g. speaker and display). For example, the input/output interface 140 may output the voice data processed by the processor 120 to the user through the speaker.

The display 150 may present various information (e.g. multimedia data and text data) to the user.

The communication interface 160 may establish a communication connection of the electronic device 101 with an external device (e.g. electronic device 104 and server 106). For example, the communication interface 160 connects to the network 162 through a wireless or wired link for communication with the external device. Examples of the wireless communication technology may include wireless fidelity (Wi-Fi), Bluetooth (BT), Near Field Communication (NFC), GPS, and cellular communication technology (e.g. Long Term Evolution (LTE), LTE-Advanced (LTE-A), Code Division Multiple Access (CDMA), Wideband CDMA (WCDMA), Universal Mobile Telecommunication System (UMTS), Wireless-Broadband (WiBro), and General System for Mobile communications (GSM)). Examples of the wired communication technology may include Universal Serial Bus (USB), High Definition Multimedia Interface (HDMI), Recommended Standard 232 (RS-232), and Plain Old Telephone Service (POTS).

According to an embodiment, the network 162 may be a telecommunication network. The communication network may include at least one of computer network, Internet, Internet of Things, and telephone network. According to an embodiment, the communication protocol between the electronic device 101 and an external device (e.g. transport layer protocol, data link layer protocol, and physical layer protocol) may be supported by at least one of the applications 134, API 133, middleware 132, kernel 131, or communication interface 160.

The function processing module 170 can process information obtained from other components (for example, memory 130 or input/output interface 140) and provide the processing result for a user in various methods. Although the function processing module 170 is illustrated as an independent component from other components, the function processing module 170 may include a portion of other components or may be included in other components. For example, the function processing module 170 may include a specific sensor corresponding to the input/output interface 140 or may be included in the processor 120. Further, the function processing module 170 can receive user's fingerprint information by using the sensor and identify whether the corresponding information is identical to data pre-stored in a database. Further, the function processing module 170 can perform a function of utilizing the fingerprint in various methods. For example, the function processing module 170 can generate a password by using at least one of a fingerprint input time, fingerprint input direction, or fingerprint input sequence.

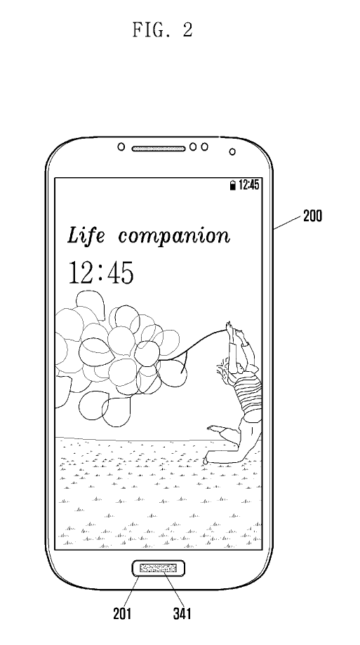

FIG. 2 is a drawing illustrating an example of electronic device 200 according to an embodiment of the present disclosure.

Referring to FIG. 2, a fingerprint sensor 341 configured to detect a fingerprint input may be located at a specific point of the electronic device 200 according to an embodiment of the present disclosure. For example, the fingerprint sensor 341 may be formed at a point which a home key 201 exists as shown in FIG. 2. However, the present disclosure is not limited to this, and the fingerprint sensor 341 may be formed in various types and at various locations. For example, the fingerprint sensor 341 may be formed on a screen of electronic device 200. Like this, the electronic device 200 according to various embodiments of the present disclosure may include a fingerprint sensor 341 configured in various types and installed at various locations.

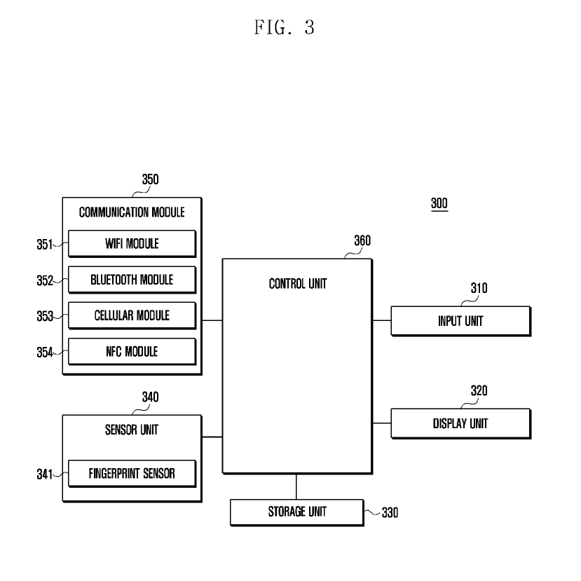

FIG. 3 is a block diagram illustrating a schematic configuration of electronic device 300 according to an embodiment of the present disclosure.

Referring to FIG. 3, the electronic device 300 may include an input unit 310, display unit 320, storage unit 330, sensor unit 340, communication module 350, and control unit 360. The sensor unit 340 may further include a fingerprint sensor 341. The communication module 350 may include a WiFi module 351, a BT module 352, a cellular module 353, and a NFC module 354.

The input unit 310 according to an embodiment of the present disclosure can include a touch panel and a key input device, and thereby can receive a touch input and a touch gesture input performed for communication connection of the electronic device 300. For example, when performing wireless communication between devices, the input unit 310 can receive a touch input for selecting an electronic device from a search list of peripheral electronic device in order to perform wireless communication.

Further, the input unit 310 can receive a touch input for selecting a communication module icon separately set to activate or deactivate a corresponding communication module with a fingerprint mode. In more detail, a communication module icon dedicated to the fingerprint mode may exist in the electronic device according to various embodiments of the present disclosure. For example, if a fingerprint mode dedicated WiFi icon exists, the control unit 360 can control to display a requesting message for a fingerprint input by selecting the icon. If a fingerprint is input after selecting the icon, the control unit 360 can automatically activate the WiFi module with the fingerprint mode. If the icon is selected again in the state of activation, the WiFi module can be switched to an inactive state. Like this, a fingerprint mode dedicated icon may exist in the electronic device in order to switch a communication module to an active or inactive state.

The display unit 320 can display a screen related to the communication of the electronic device 300. For example, when switching an operating mode of the communication module, the display unit 320 can display a mode change icon in a desktop screen or in a hidden menu. The hidden menu is not displayed in the screen and appears when a specific point is touched or dragged. The hidden menu may include a plurality of setting items. Further, when performing communication between devices, the display unit 320 can display a list of communicable peripheral devices in the screen. Further, the display unit 320 can display by identifying whether the communication is a fingerprint mode or a normal mode. For example, when the WiFi module is activated with the fingerprint mode, a WiFi mark of fingerprint mode may be displayed differently from a WiFi mark of normal mode.

The storage unit 330 can pre-store user's fingerprint information. For example, fingerprint image patterns distinguished by right and left hands, and finger types such as thumb and index finger may be prepared as database of fingerprint information. The database may be used for user authentication as a comparison object in fingerprint recognition. Like this, the pre-stored database may be used as criteria for identifying whether a newly input fingerprint is identical to a registered user's fingerprint. Further, the fingerprint database can be used as a criteria for identifying a finger type (for example, thumb of right hand) corresponding to the newly input fingerprint. Further, the storage unit 330 can store programs and commands for generating an authentication key by identifying whether a fingerprint is input and by using a fingerprint input sequence according to various embodiments of the present disclosure. Further, the storage unit 330 can store programs and commands for changing the state of communication module to the fingerprint mode responding to the fingerprint input.

The sensor unit 340 may include a fingerprint sensor 341 configured to detect a fingerprint input. The fingerprint sensor 341 may be formed to detect a fingerprint pattern when a finger contacts with a specific area. For example, the fingerprint sensor 341 may be installed at the location of home key 201 in the electronic device. Further, the fingerprint sensor 341 may be installed in various locations such as a bezel of electronic device or a partial area of screen. If a contact of specific finger is detected, the fingerprint sensor 341 can input a fingerprint image by scanning the fingerprint. Further, characteristics of fingerprint extracted from the fingerprint image through the fingerprint sensor 341 may be stored in a database. The fingerprint information can be used as data for user authentication if the input fingerprint is identical to a stored fingerprint image. The fingerprint can be used for generating a password according to various embodiments of the present disclosure. Here, the password may be generated so as to indicate a specific sequence of fingers such as a thumb, index finger, and middle finger. Information (fingerprint image pattern, fingerprint input sequence, and fingerprint input direction) related to the input fingerprint is transmitted to the control unit 360 and used for identifying whether it is identical to a pre-input fingerprint image pattern and the generated password.

The fingerprint sensor 341 can input other information related to the fingerprint besides the fingerprint image. For example, a specific fingerprint sensor 341 can detect a finger movement direction generated when the finger contacts with the sensor or detaches from the sensor. Further, the fingerprint sensor 341 can detect an elapsed time while the finger contacts with the sensor. Further, the fingerprint sensor 341 can support to input various factors related to the fingerprint. The detected factors of fingerprint can be sued for generating a password. For example, when the fingerprint sensor 341 is used for detecting a fingerprint input time, the password can be generated by including a fingerprint input time such as thumb: 1 sec, index finger: 2 sec, and middle finger: 1 sec.

The communication module 350 can support so that the electronic device performs wired/wireless communication with another electronic device or a server. When various communication functions such as BT, WiFi, and NFC are activated in the electronic device 300, the communication module 350 can search a connectible electronic device from the surroundings. Further, the communication module 350 can identify the type of connectible electronic device in the surroundings, provide an authentication method when communicating with the corresponding electronic device, and transmit the corresponding information to the control unit 360. For example, if a user intends to perform connection between devices by using WiFi, the communication module 350 can search for and detect a communicable device from the surroundings by using the WiFi. Further, the communication module 350 (for example, WiFi module) can detect an electronic device whose communication mode is the fingerprint mode. If only one device connectible to the electronic device 300 is detected, the communication module 350 can perform an operation of establishing a communication connection with the detected device without a separate selection procedure. Further, if a plurality of devices connectible to the electronic device 300 is detected, the communication module 350 can communicate with a specific device selected by the user.

The control unit 360 according to an embodiment of the present disclosure can identify whether the communication module 350 is activated by accompanying a fingerprint input. If a specific communication function (for example, WiFi) is activated by accompanying a fingerprint input, the control unit 360 can operate the communication mode as a fingerprint mode. Further, if the communication module 350 is activated with the fingerprint mode, a screen display state can be set so that the fingerprint mode is distinguished.

In more detail, when generating a password, the control unit 360 can generate a fingerprint password according to a fingerprint input sequence through the fingerprint sensor 341. The fingerprint may be input several times according to a specific sequence such as a thumb, index finger, middle finger, and middle finger of the right hand. In this example, the number of fingerprint inputs is 4, however according to the type of fingerprint sensor 341, the number of fingerprint inputs may not be limited to this example. Further, factors for generating a password may include a fingerprint input time besides the fingerprint input sequence. The fingerprint sensor can detect a contact time of corresponding fingerprint with the sensor as well as a pattern of input fingerprint, for example, thumb: 2 sec, middle finger: 1 sec, and index finger: 1 sec. Like this, if the fingerprint input time is detected additionally, the control unit 360 can generate a password by including factors of input fingerprint pattern and fingerprint input time.

The control unit 360 can identify whether a fingerprint pattern detected through the fingerprint sensor 341 is identical to user's fingerprint information pre-stored in the storage unit 330. When communication with a peripheral electronic device is required, the control unit 360 can identify whether both communication modules of user's device and counterpart device are activated. Alternatively, the control unit 360 can identify by comparing a password generated by a user's fingerprint input with a password of peripheral electronic device. If the passwords are identical, the control unit 360 can control the communication module 350 to communicate with the counterpart electronic device.

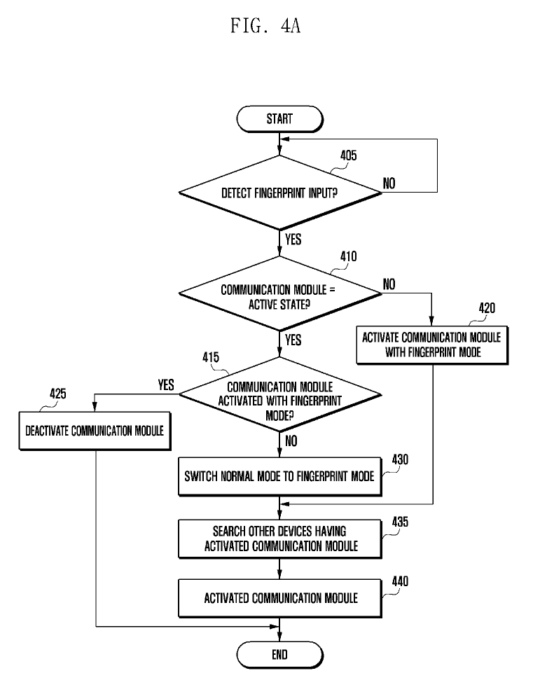

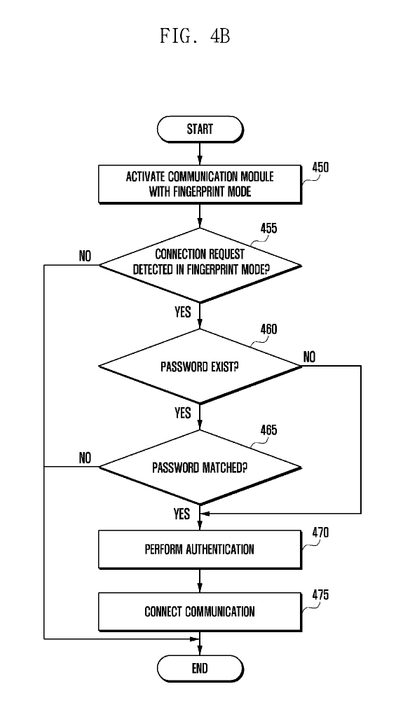

Hereinafter, a communication method using a fingerprint input according to an embodiment of the present disclosure is described referring to FIGS. 4A to 6.

FIGS. 4A and 4B are flowcharts illustrating a procedure of communication connection performed in an electronic device according to an embodiment of the present disclosure.

Referring to FIG. 4A, the control unit 360 identifies whether a fingerprint input through the fingerprint sensor is authenticated at operation 405. If the fingerprint is authenticated, the control unit 360 identifies whether the communication module is in an active state at operation 410. If the communication module is in an inactive state, the control unit 360 controls to activate the communication module with a fingerprint mode at operation 420. Namely, the operation 420 can also be performed in case that the communication module performs only the fingerprint input function in the inactive state. In case that the control unit 360 activates the communication module from an inactive state to a fingerprint mode, a method of continuously inputting a fingerprint after selecting a communication module icon (for example, WiFi icon) can be used or a method of inputting a fingerprint can be used if a fingerprint input screen is displayed after selecting a fingerprint mode dedicated communication module icon.

If the communication module is identified to be active at operation 410, the control unit 360 identifies whether the communication module is activated with a fingerprint mode at operation 415. If the communication module is identified to be active with a fingerprint mode at operation 415, the control unit 360 deactivates the communication module at operation 425. The control unit 360 can also switch the communication module to a normal mode at operation 425. Alternatively, the control unit 360 may utilize a separate user input to individually perform the operation of deactivating the communication module and the operation of switching the fingerprint mode to the normal mode.

However, if the communication mode is identified not to be a fingerprint mode at operation 415, the control unit 360 controls the communication mode to be switched from the normal mode to the fingerprint mode at operation 430.

If operation 420 or 430 is completed, the control unit 360 searches for and detects another device whose communication module is activated with a fingerprint mode at operation 435. Alternatively, the control unit 360 can display a name of electronic device which has been connected with a fingerprint mode before. The name of the electronic device which has been connected with a fingerprint mode before may be differently displayed in a search list according to the activation of fingerprint mode. Subsequently, the control unit 360 performs a connection with a detected device (it is assumed that only one device is detected) at operation 440. If a plurality of devices is detected at operation 440, the control unit 360 can connect to a device selected by various methods (for example, direct device selection and automatic device selection according to the intensity of signal). If the connection is completed, an informing means such as a message or a popup window may be displayed in a screen.

FIG. 4B illustrates a procedure of communication connection in the view of peripheral electronic device which received a connection request signal. Here, the peripheral electronic device shown in FIG. 4B is assumed to have a communication module activated with a fingerprint mode. Each component required for implementation of present disclosure exists equally in the peripheral electronic device, and thereby the same mark is used as the electronic device sending a connection request signal. Firstly, the control unit 360 of the peripheral electronic device activates a communication module with a fingerprint mode at operation 450. Subsequently, the control unit 360 identifies whether a connection request signal is received through the communication module 350 in the fingerprint mode at operation 455. If the connection request signal is not detected in the fingerprint mode, the operation of communication connection corresponding to FIG. 4B may be terminated. If the connection request signal is detected in the fingerprint mode, the control unit 360 identifies whether a password dedicated to the fingerprint mode exists at operation 460. For example, if a password doesn't exist in the information transmitted by including in the connection request signal, the control unit 360 performs authentication in the fingerprint mode at operation 470. Here, the peripheral electronic device is assumed to operate without a password in the fingerprint mode. Although not shown in the drawing, the operation of FIG. 4B may be terminated in case that the password is not included in the connection request signal although the peripheral electronic device has a password in the fingerprint mode.

Alternatively, if a password is included in the connection request signal, the control unit 360 identifies whether passwords are identical between devices at operation 465. For example, the control unit 360 can decide that passwords are discordant, if a password included in the connection request signal and a password generated in the peripheral electronic device are not identical, or if a password is not generated in the peripheral electronic device. If the passwords between devices (electronic device requested for connection and peripheral electronic device) are not identical, the procedure of FIG. 4B can be terminated. Alternatively, if the passwords between devices are identical, authentication (fingerprint mode and password authentication) is performed at operation 470, and communication between devices is connected at operation 475.

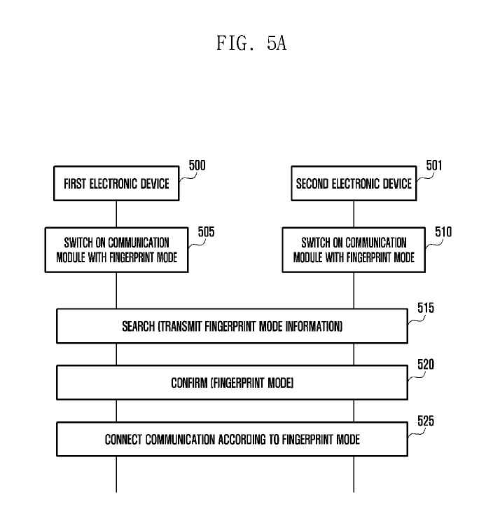

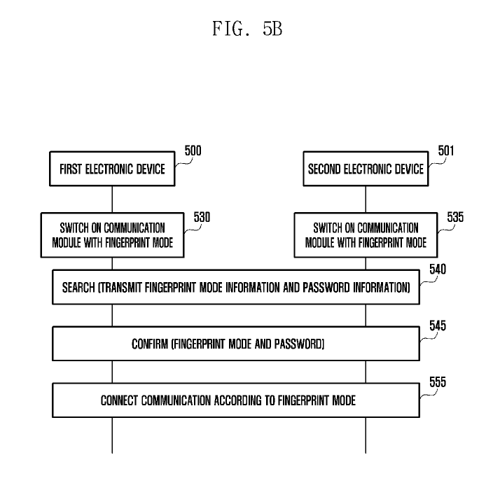

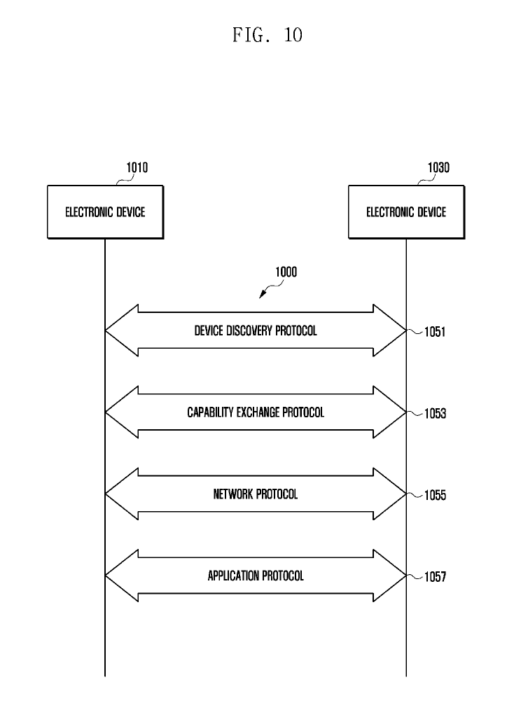

FIGS. 5A to 5B are flowcharts illustrating a procedure of establishing a communication between electronic devices by using fingerprint mode information according to an embodiment of the present disclosure This procedure may operate same as description of FIG. 10.

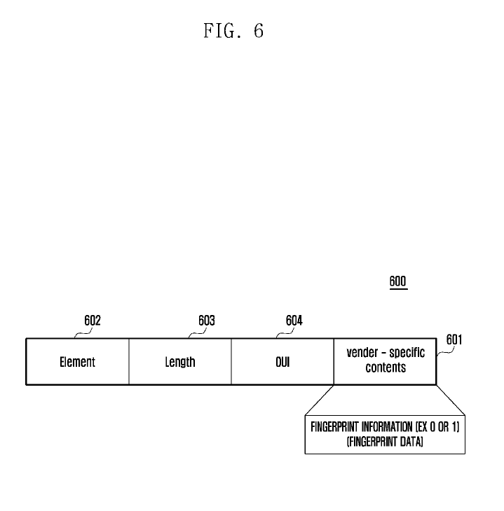

Referring to FIG. 5A, a first electronic device 500 switches on a communication module with a fingerprint mode at operation 505. The communication module can support communication between device such as a WiFi, NFC, and BT. According to an embodiment of the present disclosure, a second electronic device 501 also switches on a communication module with a fingerprint mode in order to communicate with the first electronic device 500 at operation 510. In order to set the fingerprint mode, an operation may be performed to identify whether an input fingerprint pattern is identical to one of fingerprints stored in each electronic device. After activating the communication module with a fingerprint mode, the first electronic device 500 transmits a search signal including fingerprint mode information to the second electronic device 501 at operation 515. The search signal may include a beacon signal and a probe signal. The search signals may be configured to include data required for discovering a connectible device and forming a communication channel. If the communication module is activated with a fingerprint mode according to an embodiment of the present disclosure, fingerprint mode information may be included in the search signal. In more detail, the fingerprint mode information may be transmitted by including at least one of a beacon signal, probe signal, or another connection signal. When the communication module is activated, the fingerprint mode information may mean data for indicating availability of fingerprint mode. Namely, the fingerprint mode information may mean data of which the communication module is activated with a fingerprint mode or a normal mode. A transmission format for fingerprint mode information is described referring to FIG. 6.

FIG. 6 is a block diagram illustrating a format 600 of connection request signal according to an embodiment of the present disclosure.

Referring to FIG. 6, the format 600 may include an element 602, length 603, Organizationally Unique Identifier (OUI) 604, and vender specific contents 601. Fingerprint information may be included in the vender specific contents 601. The availability of fingerprint mode may be included in the fingerprint information, and may be indicates as 0 or 1. The location of fingerprint information in the search signal is not limited to the vender specific contents.

Like this, peripheral electronic devices can be searched when connecting devices having switched on communication modules.

Referring back to FIG. 5A, an operation is performed to identify whether the communication mode of the first electronic device 500 and second electronic device 501 are fingerprint modes at operation 520. After the searching procedure, the second electronic device 501 can identify the fingerprint mode information included in the search signal. By using the search signal, the first electronic device 500 and the second electronic device 501 can identify each other whether the communication mode is a fingerprint mode. For example, the fingerprint mode information may be assumed to have a value 1 in the fingerprint mode and a value 0 in the normal mode. In more detail, if the communication module of the first electronic device 500 is activated with a fingerprint mode, the fingerprint mode information transmitted to the second electronic device 501 may have the value 1. Subsequently, the second electronic device 501 can identify whether its communication mode is identical to that of the first electronic device based on the received fingerprint mode information at operation 520.

The operation 520 may accompany an operation of signal exchange between the second electronic device 501 and the first electronic device 500. If both devices are identified to have a fingerprint mode at operation 520, both devices can perform authentication and communication connection between devices at operation 525. If the communication connection is not established within a predetermined time after the entering a fingerprint mode, a connection try can be canceled.

FIG. 5B illustrates a procedure of performing connection between devices when entering a fingerprint mode with a fingerprint password. Here, it is assumed that the first electronic device 500 and the second electronic device 501 are operated in the fingerprint mode by using the fingerprint password which can be generated by using a finger input sequence, and it is assumed that each password is identical. Firstly, communication modules of the first electronic device 500 and second electronic device 501 are activated with a fingerprint mode by receiving a fingerprint password respectively at operation 530 and operation 535. Subsequently, the first electronic device 500 transmits a search signal to the second electronic device 501 at operation 540. As already described in FIG. 5A, the search signal may include a beacon signal and a probe signal. Differently from FIG. 5A, the connection request signal transmitted at operation 540 may include not only the fingerprint mode information but also fingerprint password information (for example, a notice for inputting a password). Together with the first electronic device 500, the second electronic device 501 identifies a fingerprint mode state and authenticates each other by confirming the fingerprint password at operation 545. Subsequently, the first electronic device 500 and the second electronic device 501 establish a communication connection each other according to the fingerprint mode at operation 555.

In more detail, the password can be generated by analyzing fingerprint patterns input several times. For example, if the fingerprints input sequence is a thumb, index finger, index finger, and middle finger, the control unit 360 identifies the sequence of input fingerprint patterns: thumb, index finger, index finger, and middle finger by comparing with pre-stored user's fingerprint information, and can generate a password by encoding them. For the convenience in description, fingerprints are described based on the right hand. If the numbers from 1 to 5 are assigned to from the thumb to little finger, the password may be encodes as ‘1223’. Like this, the control unit 360 can identify the sequence of input fingerprint patterns by comparing with pre-stored fingerprint patterns and generate a password according to the sequence of fingerprints. Further, besides the fingerprint input sequence, fingerprint input direction and input time may be used as factors for generating a password. The fingerprint input direction may be decided according to whether a finger contacted the fingerprint sensor 341 moves from the top to the bottom or from the bottom to the top. Alternatively, the fingerprint input direction may be decided according to whether a finger contacted the fingerprint sensor 341 moves from the right to the left or from the left to the right. The input time may mean how long each fingerprint stayed on the sensor. For example, the fingerprint sensor 341 can identify a contact time of each finger such as index finger: 2 sec, thumb: 1 sec, and middle finger: 1 sec. Namely, the password may be set based on the fingerprint input sequence, or by including additional information such as a fingerprint input time and a fingerprint input direction.

If a connection with a peripheral electronic device is not established within a predetermined time after generating the password according to various embodiments of the present disclosure, the password can be canceled. Namely, if a peripheral electronic device is not detected after generating the password or a connection is not established due to a weak signal, the password may have to be newly set. Further, if the password becomes invalid, the fingerprint mode can be switched to the normal mode or the communication module can be deactivated.

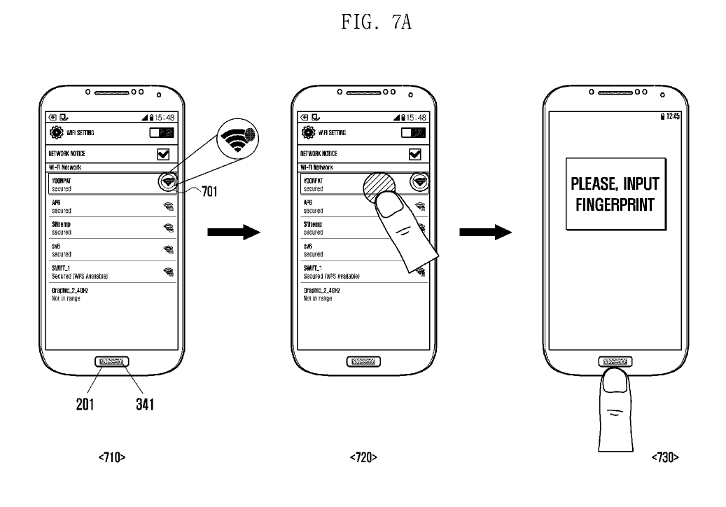

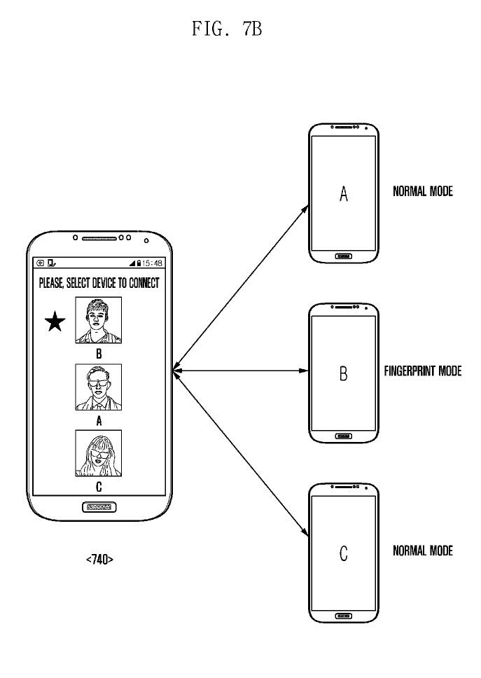

The above description has been made by assuming that the number of peripheral electronic device set with a fingerprint mode is only one while searching the peripheral devices. However, a plurality of peripheral electronic devices may be detected through the search operation according to various embodiments of the present disclosure. This will be described referring to FIGS. 7A and 7B.

FIGS. 7A and 7B are screen examples illustrating a search list of connectible peripheral electronic devices in an electronic device according to an embodiment of the present disclosure.

FIG. 7A illustrates operations for connecting communication with a peripheral electronic device having a communication module (for example, WiFi module) activated with a fingerprint mode. Firstly, screen 710 of FIG. 7A shows an example which displays a communication signal of peripheral electronic device in the screen of electronic device. Among the list of communication signals displayed in the screen, a mark indicating an electronic device having a communication module activated with a fingerprint mode can be distinguished with a fingerprint mode mark 701 as shown in the drawing. The fingerprint mode mark 701 may be formed in a fingerprint shape at the top right so that it can be distinguished from a communication signal mark of the normal mode. Like this, a corresponding communication signal mark is displayed differently according to the setting of fingerprint mode, and thereby a user can easily identify an electronic device activated with a fingerprint mode from the search list of peripheral devices. Screen 720 shows a user operation of selecting a peripheral device indicated with a fingerprint mode mark from the search list of peripheral devices in order to connect with a specific electronic device having a communication module activated with a fingerprint mode. The user selection procedure can be performed when the communication mode of electronic device is not a fingerprint mode, when the communication mode of user electronic device is not activated, or when a plurality of electronic device activated with a fingerprint mode is detected by the user electronic device. If the electronic device activates the communication module with a fingerprint mode and a specific electronic device set with a fingerprint mode is selected from the search list as shown by screen 720, communication with the selected electronic device can be performed without a user input. However, if the user electronic device is not activated with a fingerprint mode (for example, when the communication module is activated with a normal mode or when the communication module is in an inactive state), a fingerprint input can be requested by selecting an electronic device set with a fingerprint mode from the screen 720. As shown by screen 730, a popup window requesting for fingerprint input can be displayed in the electronic device.

FIG. 7B illustrates screen displays distinguishing an electronic device whose communication module is activated with a fingerprint mode from the search list of peripheral devices. For example, screen 740 indicates an operation of selecting an electronic device to be connected since multimedia data (photo or video) have been already selected. Alternatively, screen 740 may show an operation of searching a peripheral electronic device to be connected through a communication channel for data transmission and reception. Peripheral devices A, B, and C are shown in the right side, and it is assumed that only the communication module (for example, BT module) of electronic device B is activated with a fingerprint mode. Like this, if an electronic device set with a fingerprint mode exists among communicable peripheral electronic devices, the electronic device set with the fingerprint mode can be differently displayed in the list of peripheral electronic devices as shown by screen 740. In order to distinguish the electronic device set with the fingerprint mode, a classification symbol may be displayed near by a mark indicating each electronic device (for example, characteristic code of device and user's photo).

Operations for performing communication between devices have been described by using a communication module activated with a fingerprint input. However, various embodiments of the present disclosure are not limited to this example. For example, the fingerprint information (or fingerprint mode information and password) can be also used in case of performing communication between a device and a server.

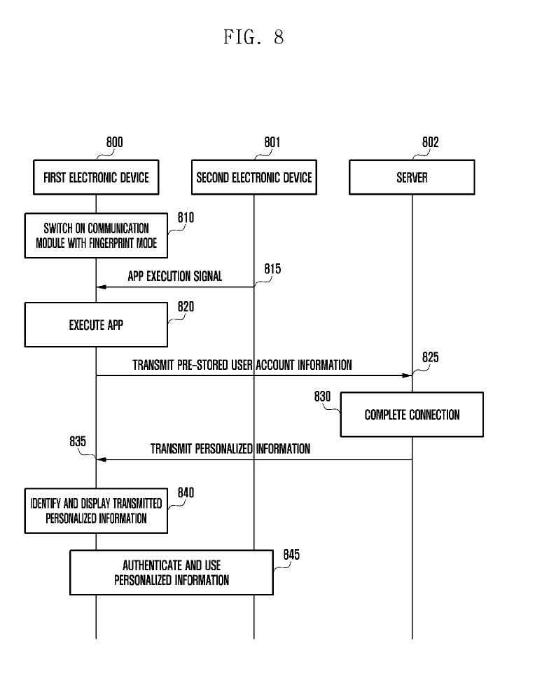

FIG. 8 is a flowchart illustrating a procedure of displaying a search list of connectible peripheral electronic devices in an electronic device according to various embodiments of the present disclosure.

Referring to FIG. 8, a first electronic device 800 may be an electronic device of the related art and a second electronic device 501 may be an electronic device in an offline store (for example, POS terminal). The offline store may mean an area having a limited space such as a café, restaurant, and baseball ground. If a user approaches or moves into a corresponding space, the service related to FIG. 8 can be automatically provided.

Firstly, the first electronic device 800 activates a communication module with a fingerprint mode at operation 810. If the user visits the offline store, the first electronic device 800 can receive an app execution signal from the second electronic device 801 located in the offline store at operation 815. The first electronic device 800 may receive an app execution signal not from the second electronic device 801 but from another signal transmitter installed in the store. The app execution signal may have a characteristic of randomly transmitting to adjacent electronic devices. For example, the app execution signal may be a beacon signal including specific app execution information. The app may be one operating in the store, and may provide a service so that user's personalized information (for example, membership information and exchange check information) usable in the store can be checked and used. The first electronic device 800 received the app execution signal executes the corresponding app at operation 820. If the communication module of the first electronic device 800 is activated with a fingerprint mode, the first electronic device 800 may regard the current user as a registered and authenticated user. In more detail, a procedure of identifying whether fingerprint information registered in the electronic device and input fingerprint information are identical can be performed in order to set the fingerprint mode in the electronic device. Accordingly, if a fingerprint mode is activated in a specific electronic device, it can be regards as the electronic device is being used by an authenticated user. Namely, if the fingerprint mode is set, the first electronic device 800 can connect to the corresponding app by using pre-stored user account information. For this, the first electronic device 800 transmits pre-stored user account information to a server 802 through the executing app at operation 825. The server 802 may be a device for managing user account information connected to the app and user's personalized information used in the corresponding store. If the user account information is received, the server 802 completes the processing of connection at operation 830, and transmits personalized information of corresponding account at operation 835. If the personalized information is received by the first electronic device 800, the first electronic device 800 identifies it and displays the personalized information in a screen at operation 840. The personalized information may be data usable in the corresponding store such as a user's store visit record and available exchange check. Subsequently, the personalized information displayed in the first electronic device 800 can be authenticated and used through an interaction with the second electronic device 801 at operation 845. For example, if the personalized information displayed in the first electronic device 800 is a barcode usable in the corresponding store, the second electronic device 801 can provide a coupon service by reading the barcode information.

Further, besides the fingerprint, a signature may be used for changing the communication mode according to various embodiments of the present disclosure. For example, if the user inputs a signature identical to a registered signature, the communication mode may be switched to a signature mode (corresponding to the fingerprint mode). Further, other devices having a communication module activated with a signature mode can be searched and connected.

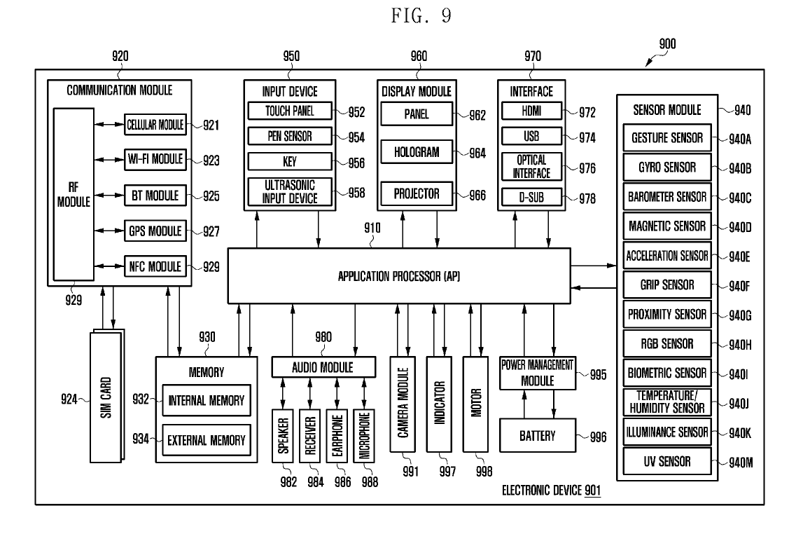

FIG. 9 is a block diagram illustrating a configuration of the electronic device according to various embodiments of the present disclosure. The electronic device 901 may be of the whole or a part of the electronic device 101.

Referring to FIG. 9, the electronic device 901 may include an Application Processor (AP) 910, a communication module 920, a Subscriber Identity Module (SIM) card 924, a memory 930, a sensor module 940, an input device 950, a display 960, an interface 970, an audio module 980, a camera module 991, a power management module 995, a battery 996, an indicator 997, and a motor 998.

The AP 910 may operate an Operating System (OS) and/or application programs to control a plurality of hardware and/or software components connected to the AP 910 and perform data-processing and operations on multimedia data. For example, the AP 910 may be implemented in the form of System on Chip (SoC). According to an embodiment, the AP 910 may include a Graphic Processing Unit (GPU) (not shown).

The communication module 920 (e.g. communication interface 160) may perform data communication with other electronic devices (e.g. electronic device 104 and server 106) through a network. According to an embodiment, the communication module 920 may include a cellular module 921, a Wi-Fi module 923, a BT module 925, a GPS module 927, an NFC module 928, and a Radio Frequency (RF) module 929.

The cellular module 921 is responsible for voice and video communication, text messaging, and Internet access services through a communication network (e.g. LTE, LTE-A, CDMA, WCDMA, UMTS, WiBro, and GSM networks). The cellular module 921 may perform identification and authentication of electronic devices in the communication network using the SIM card 924. According to an embodiment, the cellular module 921 may perform at least one of the functions of the AP 910. For example, the cellular module 921 may perform at least a part of the multimedia control function.

According to an embodiment, the cellular module 921 may include a Communication Processor (CP). The cellular module 921 may be implemented in the form of SOC. Although the cellular module 921 (e.g. communication processor), the memory 930, and the power management module 995 are depicted as independent components separated from the AP 910, the present disclosure is not limited thereto but may be embodied in a way that the AP includes at least one of the components (e.g. cellular module 921).

According to an embodiment, each of the AP 910 and the cellular module 921 (e.g. communication processor) may load a command or data received from at least one of the components on a non-volatile or volatile memory and process the command or data. The AP 910 or the cellular module 921 may store the data received from other components or generated by at least one of other components in the non-volatile memory.

Each of the Wi-Fi module 923, the BT module 925, the GPS module 927, and the NFC module 928 may include a processor for processing the data it transmits/receives. Although the cellular module 921, the Wi-Fi module 923, the BT module 925, the GPS module 927, and the NFC module 928 are depicted as independent blocks; at least two of them (e.g. communication processor corresponding to the cellular module 921 and Wi-Fi processor corresponding to the Wi-Fi module 923) may be integrated in the form of SoC.

The RF module 929 is responsible for data communication, e.g. transmitting/receiving RF signals. Although not depicted, the RF module 929 may include a transceiver, a Power Amp Module (PAM), a frequency filter, and a Low Noise Amplifier (LNA). The RF module 929 also may include the elements for transmitting/receiving electric wave in free space, e.g. conductor or conductive wire. Although FIG. 9 is directed to the case where the Wi-Fi module 923, the BT module 925, the GPS module 927, and the NFC module 928 are sharing the RF module 929, the present disclosure is not limited thereto but may be embodied in a way that at least one of the Wi-Fi module 923, the BT module 925, the GPS module 927, and the NFC module 928 transmits/receives RF signals an independent RF module.

The SIM card 924 may be designed so as to be inserted into a slot formed at a predetermined position of the electronic device. The SIM card 924 may store unique identity information (e.g. Integrated Circuit Card Identifier (ICCID)) or subscriber information (e.g. International Mobile Subscriber Identity (IMSI)).

The memory 930 (e.g. memory 130) may include at least one of the internal memory 932 and an external memory 934. The internal memory 932 may include at least one of a volatile memory (e.g. Dynamic Random Access Memory (DRAM), Static RAM (SRAM), Synchronous Dynamic RAM (SDRAM) or a non-volatile memory (e.g. One Time Programmable Read Only Memory (OTPROM), Programmable ROM (PROM), Erasable and Programmable ROM (EPROM), Electrically Erasable and Programmable ROM (EEPROM), mask ROM, flash ROM, Not AND (NAND) flash memory, or Not OR (NOR) flash memory)

According to an embodiment, the internal memory 932 may be a Solid State Drive (SSD). The external memory 934 may be a flash drive such as Compact Flash (CF), Secure Digital (SD), micro-SD, Mini-SD, extreme Digital (xD), and Memory Stick. The external memory 934 may be connected to the electronic device 901 through various interfaces functionally. According to an embodiment, the electronic device 901 may include a storage device (or storage medium) such as hard drive.

The sensor module 940 may measure physical quantity or check the operation status of the electronic device 901 and convert the measured or checked information to an electric signal. The sensor module 940 may include at least one of gesture sensor 940A, Gyro sensor 940B, atmospheric pressure sensor 940C, magnetic sensor 940D, acceleration sensor 940E, grip sensor 940F, proximity sensor 940G, color sensor 940H (e.g. Red, Green, Blue (RGB) sensor), bio sensor 940I, temperature/humidity sensor 940J, illuminance sensor 940K, and Ultra Violet (UV) sensor 940M. Additionally or alternatively, the sensor module 940 may include E-nose sensor (not shown), Electromyography (EMG) sensor (not shown), Electroencephalogram (EEG) sensor (not shown), Electrocardiogram (ECG) sensor (not shown), Infrared (IR) sensor (not shown), iris sensor (not shown), and fingerprint sensor (not shown). The sensor module 940 may further include a control circuit for controlling at least one of the sensors included therein.

The input device 950 may include a touch panel 952, a (digital) pen sensor 954, keys 956, and an ultrasonic input device 958. The touch panel 952 may be one of capacitive, resistive, infrared, microwave type touch panel. The touch panel 952 may include a control circuit. In the case of the capacitive type touch panel, it is possible to detect physical contact or approximation. The touch panel 952 may further include a tactile layer. In this case, the touch panel 952 may provide the user with haptic reaction.

The (digital) pen sensor 954 may be implemented with a sheet with the same or similar way as touch input of the user or a separate recognition sheet. The keys 956 may include physical buttons, optical key, and keypad. The ultrasonic input device 958 is a device capable of checking data by detecting sound wave through a microphone 988 and may be implemented for wireless recognition. According to an embodiment, the electronic device 901 may receive the user input made by means of an external device (e.g. computer or server) connected through the communication module 920.

The display 960 (e.g. display 150) may include a panel 962, a hologram device 964, and a projector 966. The panel 962 may be a Liquid Crystal Display (LCD) panel or an Active Matrix Organic Light Emitting Diodes (AMOLED) panel. The panel 962 may be implemented so as to be flexible, transparent, and/or wearable. The panel 962 may be implemented as a module integrated with the touch panel 952. The hologram device 964 may present 3-dimensional image in the air using interference of light. The projector 966 may project an image to a screen. The screen may be placed inside or outside the electronic device. According to an embodiment, the display 960 may include a control circuit for controlling the panel 962, the hologram device 964, and the projector 966.

The interface 970 may include a HDMI 972, an USB 974, an optical interface 976, and a D-subminiature (D-sub) 978. The interface 970 may include the communication interface 160 as shown in FIG. 1. Additionally or alternatively, the interface 970 may include a Mobile High-definition Link (MHL) interface, a SD/MultiMediaCard (MMC) card interface, and infrared Data Association (irDA) standard interface.

The audio module 980 may convert sound to electric signal and vice versa. At least a part of the audio module 980 may be included in the input/output interface 140 as shown in FIG. 1. The audio module 980 may process the audio information input or output through the speaker 982, the receiver 984, the earphone 986, and the microphone 988.

The camera module 991 is a device capable of taking still and motion pictures and, according to an embodiment, includes at least one image sensor (e.g. front and rear sensors), a lens (not shown), and Image Signal Processor (ISP) (not shown), or a flash (e.g. LED or xenon lamp) (not shown).

The power management module 995 may manage the power of the electronic device 901. Although not shown, the power management module 995 may include a Power Management Integrated Circuit (PMIC), a charger IC, a battery, and a battery or fuel gauge.

The PMIC may be integrated into an integrated circuit or SoC semiconductor. The charging may be classified into wireless charging and wired charge. The charger IC may charge the battery and protect the charger against overvoltage or overcurrent. According to an embodiment, the charger IC may include at least one of wired charger and wireless charger ICs. Examples of the wireless charging technology includes resonance wireless charging and electromagnetic wave wireless charging, and there is a need of extra circuit for wireless charging such as coil loop, resonance circuit, and diode.

The battery gauge may measure the residual power of the battery 996, charging voltage, current, and temperature. The battery 996 may store or generate power and supply the stored or generated power to the electronic device 901. The battery 996 may include a rechargeable battery or a solar battery.

The indicator 997 may display operation status of the electronic device 901 or a part of the electronic device, booting status, messaging status, and charging status. The motor 998 may converts the electronic signal to mechanical vibration. Although not shown, the electronic device 901 may include a processing unit (e.g. GPU) for supporting mobile TV. The processing unit for supporting the mobile TV may be able to processing the media data abiding by the broadcast standards such Digital Multimedia Broadcasting (DMB), Digital Video Broadcasting (DVB), and media flow.

FIG. 10 is a flowchart illustrating communication protocols 1000 between electronic devices (for example, electronic devices 1010 and 1030) according to various embodiments of the present disclosure.

Referring to FIG. 10, the communication protocol 1000 may include device discovery protocol 1051, capability exchange protocol 1053, network protocol 1055, and application protocol 1057.

According to an embodiment of the present disclosure, the device discovery protocol 1051 may be a protocol for which electronic devices (for example, electronic device 1010 or electronic device 1030) can detect a communicable external electronic device or connect to the detected external electronic device. For example, the electronic device 1010 (for example, electronic device 101) can detect an electronic device 1030 (for example, electronic device 104) as a communicable device with the electronic device 1010 by using the device discovery protocol 1051 through a communication method (for example, WiFi, BT, and USB) utilized in the electronic device 1010. For the communication with the electronic device 1030, the electronic device 1010 can obtain and store identification information of the detected electronic device 1030 by using the device discovery protocol 1051. For example, the electronic device 1010 can open a communication channel for the electronic device 1030 based on the identification information.

According to an embodiment of the present disclosure, the device discovery protocol 1051 may be a protocol for cross-authentication between a plurality of electronic devices. For example, the electronic device 1010 can perform authentication between the electronic device 1010 and electronic device 1030 based on communication information for connecting to the electronic device 1030 (for example, Media Access Control (MAC) address, Universally Unique Identifier (UUID), Subsystem Identification (SSID), Internet Protocol (IP) address).

According to an embodiment of the present disclosure, the capability exchange protocol 1053 may be a protocol for exchanging information related to a supportable service function at least one of the electronic device 1010 and electronic device 1030. For example, the electronic device 1010 and electronic device 1030 can exchange information related to a service function currently provided by each electronic device through the capability exchange protocol 1053. The exchangeable information may include identification information directing a specific service among a plurality of supportable services in the electronic device 1010 and electronic device 1030. For example, the electronic device 1010 can receive identification information of a specific service provided by the electronic device 1030 through the capability exchange protocol 1053. In this case, the electronic device 1010 can identify whether the electronic device 1010 can support the specific service based on the received identification information.

According to an embodiment of the present disclosure, the network protocol 1055 may be a protocol for controlling a data flow transmitted and received to provide and synchronize a service between electronic devices (for example, electronic device 1010 and electronic device 1030) connected for communication. For example, at least one of the electronic device 1010 and electronic device 1030 may perform an error control or data quality control by using the network protocol 1055. Additionally or alternatively, the network protocol 1055 can decide a data format transmitted and received between the electronic device 1010 and electronic device 1030. Further, at least one of the electronic device 1010 and electronic device 1030 can perform a session management (for example, session connection or session termination) for data exchange between the electronic devices by using the network protocol 1055.

According to an embodiment of the present disclosure, the application protocol 1057 may be a protocol for providing a procedure or information in order to exchange data related to a service for an external electronic device. For example, the electronic device 1010 (for example, electronic device 101) can provide a service for the electronic device 1030 (for example, electronic device 104) or server 106 through the application protocol 1057.

According to an embodiment of the present disclosure, the communication protocol 1000 may include a standard communication protocol, communication protocol designated by a person or organization (for example, communication protocol designated by a communication device manufacturer or network provider), or their combinations.

The term “module” according to the various embodiments of the present disclosure, means, but is not limited to, a unit of one of software, hardware, and firmware or any combination thereof. The term “module” may be used interchangeably with the terms “unit,” “logic,” “logical block,” “component,” or “circuit.” The term “module” may denote a smallest unit of component or a part thereof. The term “module” may be the smallest unit of performing at least one function or a part thereof. A module may be implemented mechanically or electronically. For example, a module may include at least one of Application-Specific Integrated Circuit (ASIC) chip, Field-Programmable Gate Arrays (FPGAs), or Programmable-Logic Device known or to be developed for certain operations.

According to various embodiments of the present disclosure, the devices (e.g. modules or their functions) or methods may be implemented by computer program instructions stored in a non-transitory computer-readable storage medium. In the case that the instructions are executed by at least one processor (e.g. processor 120), the at least one processor may execute the functions corresponding to the instructions. The non-transitory computer-readable storage medium may be the memory 130. At least a part of the programming module may be implemented (e.g. executed) by the processor 120. At least part of the programming module may include modules, programs, routines, sets of instructions, and processes for executing the at least one function.

The non-transitory computer-readable storage medium includes magnetic media such as a floppy disk and a magnetic tape, optical media including a Compact Disc (CD) ROM and a DVD ROM, a magneto-optical media such as a floptical disk, and the hardware device designed for storing and executing program commands such as ROM, RAM, and flash memory. The programs commands include the language code executable by computers using the interpreter as well as the machine language codes created by a compiler. The aforementioned hardware device can be implemented with one or more software modules for executing the operations of the various embodiments of the present disclosure.

The module or programming module of the present disclosure may include at least one of the aforementioned components with omission of some components or addition of other components. The operations of the modules, programming modules, or other components may be executed in series, in parallel, recursively, or heuristically. Also, some operations may be executed in different order, omitted, or extended with other operations.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for communication using a fingerprint input, the method comprising:
detecting a fingerprint information input;
changing a communication mode according to the fingerprint information input;
detecting a peripheral electronic device operating in a fingerprint mode, if the changed communication mode is the fingerprint mode; and
communicating with the detected peripheral electronic device.

2. The method of claim 1, wherein the detecting of the fingerprint information input comprises identifying whether an input fingerprint pattern is identical to a pre-stored user's fingerprint pattern by comparing the input fingerprint pattern and the pre-stored user's fingerprint pattern.

3. The method of claim 1, wherein the changing of the communication mode comprises changing the communication mode to the fingerprint mode, if a communication module is in an inactive state or in a normal state.

4. The method of claim 3, wherein the changing of the communication mode to the fingerprint mode comprises setting a password generated based on a fingerprints input sequence in the fingerprint mode, if the input fingerprint information includes a plurality of fingerprint patterns.

5. The method of claim 4, wherein information corresponding to an additional factor is further included, if a fingerprint input time and a fingerprint input direction are included in the additional factor.

6. The method of claim 1, further comprising communicating with an electronic device selected from peripheral electronic devices, if a plurality of peripheral electronic devices exists.

7. The method of claim 1, wherein the communicating with the detected electronic device comprises:
transmitting a search signal including fingerprint mode information to the peripheral electronic devices; and
identifying the fingerprint mode information each other.

8. The method of claim 7, wherein the identifying of the fingerprint mode information further comprises:
transmitting a password to the detected peripheral electronic device; and
identifying the password each other, if the password is set to the fingerprint mode.

9. The method of claim 1, wherein the communication module comprises at least one of a wireless fidelity (WiFi) module, a near field communication (NFC) module, or a Bluetooth module supporting communication between devices.

10. The method of claim 1, wherein the searching of the peripheral electronic device displays a search list by distinguishing peripheral electronic devices set to the fingerprint mode and peripheral electronic devices set to a normal mode.

11. The method of claim 1, further comprising:
receiving a signature; and
changing the communication mode based on the received signature.

12. An apparatus for performing a communication using a fingerprint input, the apparatus comprising:
a communication module;
a fingerprint sensor configured to input a fingerprint;
a control unit configured to:
change a communication mode according the fingerprint input, to control the communication module to detect a peripheral electronic device operating in a fingerprint mode if the changed communication mode is the fingerprint mode, and
control to communicate with the detected peripheral electronic device operating in the fingerprint mode; and
a storage unit configured to store user's fingerprint information in order to identify whether the input fingerprint is a user's fingerprint.

13. The apparatus of claim 12, wherein the control unit identifies whether an input fingerprint pattern corresponds to a user's fingerprint based on the fingerprint information of each finger pre-stored in the storage unit.

14. The apparatus of claim 12, wherein the control unit is configured to change the communication mode to the fingerprint mode, if a communication module is in an inactive state or in a normal state when changing the communication mode.

15. The apparatus of claim 14, wherein the control unit is configured to generate a password based on the fingerprint input sequence and set the password to the fingerprint mode, if the input fingerprint information includes a plurality of fingerprint patterns when changing the communication mode to the fingerprint mode.

16. The apparatus of claim 15, wherein the control unit is configured to generate the password by further including information corresponding to an additional factor, if a fingerprint input time and a fingerprint input direction are included in the additional factor.

17. The apparatus of claim 12, wherein the control unit is configured to control the communication module to communicate with an electronic device selected from peripheral electronic devices, if a plurality of peripheral electronic devices exist.

18. The apparatus of claim 12, wherein the control unit is configured to control the communication unit to communicate with the detected electronic device by transmitting a search signal including fingerprint mode information to the peripheral electronic devices and identifying the fingerprint mode information each other when communicating with the peripheral electronic device.

19. The apparatus of claim 18, wherein the control unit is configured to control the communication module to transmit a password to the detected peripheral electronic device and identify the password each other, if the password is set to the fingerprint mode.

20. The apparatus of claim 12, wherein the communication module comprises at least one of a wireless fidelity (WiFi) module, a near field communication (NFC) module, or a Bluetooth module supporting a communication between devices.

21. The apparatus of claim 12, wherein the control unit is configured to display a search list by distinguishing peripheral electronic devices set to the fingerprint mode and peripheral electronic devices set to a normal mode when displaying the search list of the peripheral electronic devices.

22. The apparatus of claim 12, further comprising an input unit configured to input a signature,
wherein the control unit is configured to change the communication mode based on the signature, if the signature is input.

23. A non-transitory computer-readable storage media configured to store a program including instructions for execution by at least one processor, the program comprising:
first instructions for detecting a fingerprint information input;
second instructions for changing a communication mode according to the fingerprint information input;
third instructions for detecting a peripheral electronic device operating in a fingerprint mode, if the changed communication mode is the fingerprint mode; and
fourth instructions for communicating with the detected peripheral electronic device.
